(19) United States
(12) Patent Application Publication
(10) Pub. No.: US 2025/0148155 A1
(43) Pub. Date: May 8, 2025

(54) FLEXIBLE DOCUMENT MODEL AND RELATED SIMULATION METHOD

(71) Applicant: ARCA TECHNOLOGIES S.R.L., Bollengo (IT)

(72) Inventors: Samuele Libetti, Bollengo (IT); Davide Eleuteri, Bollengo (IT)

(73) Assignee: ARCA TECHNOLOGIES S.R.L., Bollengo (IT)

(21) Appl. No.: 18/927,249

(22) Filed: Oct. 25, 2024

(30) Foreign Application Priority Data
Nov. 3, 2023 (IT) 102023000023178

(51) Int. Cl. G06F 30/17; G06F 111/10

(52) U.S. Cl. CPC G06F 30/17; G06F 2111/10

(57) ABSTRACT

A model of a flexible document for use in a mechanized flexible document transport process. The flexible document is decomposed into at least one layer comprising parallelepiped-shaped rigid bodies, and each rigid body is connected to all rigid bodies that are adjacent to it by connecting elements connected to connection edges of adjacent rigid bodies. Each connection edge is connected to an edge connecting a rigid body adjacent to it by: (1) a first connection spring having a rotational stiffness about a rotation axis orthogonal to the thickness axis of said connected rigid body and to the axis where the connected rigid body is connected to the adjacent rigid body, and (2) a connecting structure selected from:
three springs having a translational stiffness along the connected rigid body's longitudinal axis, the connected rigid body's transverse axis, and the connected rigid body's thickness axis, respectively. and
a ball joint.

The present invention relates to a computer-implemented model of a flexible document, such as a banknote, and a related computer-implemented method and MultiBody simulation system of a mechanized process for the transport of flexible documents, which allows in a simple, versatile, reliable, efficient and economical way to obtain high simulation performances, analyzing the behavior of the flexible document at the microsecond, and an extremely significant reduction in prototyping and testing costs and allowing to achieve an optimization of the transport process.

In the following description, reference will be primarily made to banknotes as flexible documents. However, it should be noted that the computer-implemented model, and the related computer-implemented method and simulation system, may be applied to simulate a mechanized transport process of any other type of flexible documents, including paper documents such as checks, notes, certificates and licenses, always remaining within the scope of the present invention as defined by the appended claims.

Furthermore, in the following description, reference will be made primarily to flexible documents, in particular banknotes, made of paper. However, it should be noted that the computer-implemented model, and the related computer-implemented method and simulation system, may be applied to simulate a mechanized transport process of any flexible documents made of any other type of flexible material, such as polymeric materials, always remaining within the scope of protection of the present invention as defined by the appended claims.

It is known that today, despite the spread of digital payment systems, banknotes still play a fundamental role in the lives of people, financial institutions and every business activity. In November 2021, there were more than 27 million banknotes in circulation in the countries of the euro area. In financial institutions, it is often necessary to manage a large daily amount with deposit and withdrawal activities. Bank automation simplifies and speeds up these repetitive activities. In this context, automatic cash management machines have been developed, in particular cash recyclers.

A cash recycler is a complex machine that combines mechanics, electronics and information technology and manages the basic activities of depositing and withdrawing cash. A cash recycler keeps money safe in a safe, authenticates and counts each note, allows a quick withdrawal of the desired amount, and thus automates the entire money management cycle.

In detail, the banknotes are placed in a feeder and passed through a reader that identifies the type of banknote and authenticates it. If the banknote is counterfeit or does not meet certain requirements, for example if it is too damaged, it is automatically rejected. The banknotes are then placed in drawers or modules for future withdrawal.

Up to seven banknotes can pass through the feeder per second, making it very difficult to correctly manage the feeding phase without tearing or ruining the banknotes, and above all ensuring that one passes at a time, otherwise it will be impossible to authenticate and count them correctly.

To develop innovative banknote transport devices, and more generally innovative flexible document transport devices, it is necessary to create prototypes to study the reliability of the operation of the mechanized flexible document transport process.

This entails significant time and costs in developing innovative flexible document transport devices.

Accordingly, some simulation methods of mechanized flexible document transport processes have been developed in the prior art.

Some of such prior art simulation methods are described in JP2002352176A, JP2006235714A, US20060077246A1, U.S. Pat. No. 5,838,596A, JP2015014821A, US20100299082A1, and JP2006103877A.

However, even these solutions suffer from drawbacks, mainly due to their complexity, which also makes them expensive, and to their poor reliability and efficiency.

A purpose of the present invention is, therefore, to allow the simulation of the transport of a banknote in a feeder of a banknote transport apparatus, and more generally the transport of a flexible document in a flexible document transport apparatus.

Another purpose of the present invention is to allow such a simulation that is not limited to a specific application, but can be implemented in any system in which the banknote or flexible document is to interact.

The specific object of the present invention is a computer-implemented model of a flexible document configured for use in a computer-implemented MultiBody simulation method of a mechanized flexible document transport process, wherein the flexible document has the shape of a parallelepiped, wherein the flexible document is decomposed into one or more layers, wherein each layer of said one or more layers comprises a plurality of parallelepiped-shaped rigid bodies, wherein each rigid body has a longitudinal axis, a transverse axis orthogonal to the longitudinal axis, and a thickness axis orthogonal to both the longitudinal axis and the transverse axis, wherein each rigid body is connected to all rigid bodies adjacent to it along both its longitudinal axis and its transverse axis by means of a plurality of connecting elements connected to connection edges of adjacent rigid bodies, wherein the connection edges of each rigid body are parallel to the thickness axis, wherein each connection edge of each connected rigid body is connected to a connection edge of a rigid body adjacent to it. adjacent by means of
a first connection spring having a rotational stiffness about a rotational axis that is orthogonal to the thickness axis of said connected rigid body and to the axis along which the connected rigid body is connected to the adjacent rigid body,
   and wherein each connecting edge of each connected rigid body is also connected to a connecting edge of a rigid body adjacent to it by a connecting structure selected from the group comprising or consisting of
a set of further three connection springs consisting of a second connection spring having a translational stiffness along the longitudinal axis of said connected rigid body, a third connection spring having a translational stiffness along the transverse axis of said connected rigid body, and a fourth connection spring having a translational stiffness along the thickness axis of said connected rigid body, and
a connecting ball joint.

According to another aspect of the invention, each connecting edge of each connected rigid body may be connected to a connecting edge of a rigid body adjacent to it by:
a first connection damper having a rotational damping factor about a rotational axis that is orthogonal to the thickness axis of said connected rigid body and to the axis along which the connected rigid body is connected to the adjacent rigid body,
   and, when said connection structure consists of said set of further three connection springs, each connection edge of each connected rigid body may also be connected to a connection edge of a rigid body adjacent thereto by a set of further three connection dampers consisting of a second connection damper having a translational damping factor along the longitudinal axis of said connected rigid body, a third connection damper having a translational damping factor along the transverse axis of said connected rigid body, and a fourth connection damper having a translational damping factor along the thickness axis of said connected rigid body.

According to a further aspect of the invention, each connecting element of said plurality of connecting elements can be connected to a corresponding connecting edge of a respective rigid body of said plurality of rigid bodies at a mean plane which is parallel to both the longitudinal axis and the transverse axis of the respective rigid body and on which lies a center of mass of the respective rigid body.

According to an additional aspect of the invention, each end of the first connection damper may be connected to a corresponding connection edge of a respective rigid body of said plurality of rigid bodies on the mean plane of the respective rigid body, and, when said connection structure consists of said set of further three connection springs, each end of said further three connection dampers may be connected to a corresponding connection edge of a respective rigid body of said plurality of rigid bodies on the mean plane of the respective rigid body.

According to another aspect of the invention, said rotational stiffness of said first connection spring may be non-linear and, when said connecting structure consists of said set of further three connection springs, the translational stiffness of each of said further three connection springs may be non-linear.

According to a further aspect of the invention, said one or more layers may be two or more layers and each connecting edge of each rigid body of a layer of said two or more layers may be connected to a connecting edge of a rigid body adjacent to it along the thickness axis by a thickness connection spring having a translational stiffness along the thickness axis.

According to an additional aspect of the invention, the computer-implemented model of a flexible document can be obtained by automation by means of Python language.

According to another aspect of the invention, said flexible document may be a banknote.

The present invention also specifically provides a computer-implemented method of simulating a mechanized flexible document transport process in at least one flexible document transport machine, wherein the computer-implemented method is based on the computer-implemented model of a flexible document described above and on at least one element of said at least one flexible document transport machine modeled as a rigid body, the computer-implemented method comprising:
a first phase of detecting a contact between the flexible document and said at least one element of the flexible document transport machine, and
a second phase of calculation of contact forces,
   wherein contact between the flexible document and said at least one element of the flexible document transport machine is recognized when a distance between the flexible document and said at least one element of the flexible document transport machine is less than zero, wherein said distance is defined as the penetration depth.

According to another aspect of the invention, the first detection step may be performed by representing the flexible document and/or said at least one element of the flexible document transport machine by one or more respective mathematical functions, wherein at least one of said one or more respective mathematical functions is optionally obtained from a geometry of a CAD.

According to a further aspect of the invention, at least one of said one or more respective mathematical functions can be obtained from a CAD geometry.

According to an additional aspect of the invention, the first detection step can be performed by representing the flexible document and/or said at least one element of the flexible document transport machine by a discretization with a mesh of first-order triangular elements.

MultiBody simulation system of a mechanized process for transporting flexible documents in at least one flexible document transport machine comprising one or more processing units configured to execute the method implemented by the MultiBody simulation computer of a mechanized process for transporting flexible documents in at least one flexible document transport machine previously described.

It is a further specific object of the present invention a set of one or more computer programs comprising instructions which, when executed by one or more processing units of a MultiBody simulation system of a mechanized flexible document transport process in at least one flexible document transport machine, cause said one or more processing units to execute the computer-implemented method of MultiBody simulation of a mechanized flexible document transport process in at least one flexible document transport machine previously described.

It is a further specific object of the present invention a set of one or more memory supports readable by a computer which has stored on them the set of one or more computer programs just described.

In other words, the subject of the present invention is a CAE (Computer Aided Engineering) methodology for simulating the transport of a flexible document in a flexible document transport apparatus, such as a banknote in a feeder of a banknote transport apparatus, by producing a model of the flexible document itself which is, in particular, intended as a non-linear flexible body. Specifically, the invention is based on a modeling of the flexible document and a modeling of the contacts.

The multiple advantages offered by the invention are evident.

First of all, the invention allows the application of new and increasingly high-performance technologies.

Furthermore, it allows a reduction in prototyping and testing costs. In fact, the invention allows simulating the transport of banknotes, and more generally of flexible documents, in different construction solutions without the need to physically build prototypes, reducing costs and product development times.

Another advantage offered by the invention is the ability to investigate the behavior of the mechanized process of transporting flexible documents in operating conditions that are not easily replicable experimentally.

Furthermore, the invention allows to analyze the behavior of the banknote, and more generally of the flexible document, at the microsecond, which is not feasible even with the use of powerful video cameras, because the recording of the movement of the banknote in the feeder is difficult to achieve in practice, given the limited physical space available and the high dynamics of banknote processing. The numerical approach of the invention then leads to a better and more in-depth understanding of the physical phenomena underlying the transport of flexible documents, allowing to learn more about the regulation of the parameters while also achieving an optimization of the transport process.

The present invention will now be described, for illustrative but not limitative purposes, according to its preferred embodiments, with particular reference to the Figures of the attached drawings, in which:

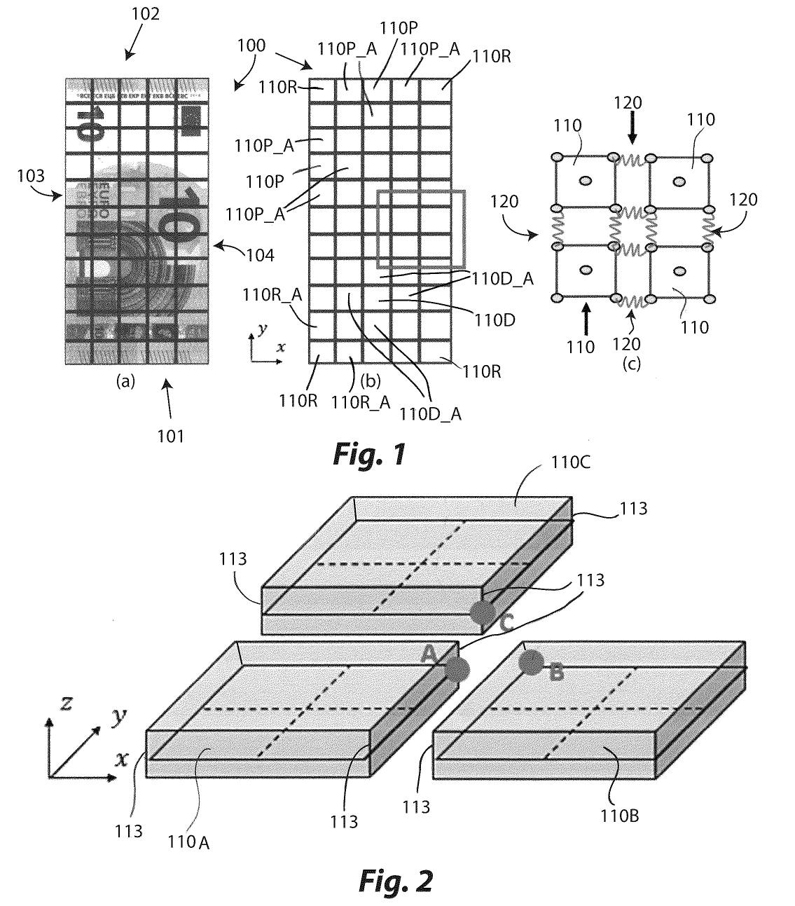

FIG. 1 shows a plan view of a banknote decomposed into a plurality of rigid parallelepiped-shaped bodies (FIG. 1a), a plan view of the plurality of rigid parallelepiped-shaped bodies (FIG. 1b), and a detail of the plurality of rigid parallelepiped-shaped bodies connected to each other of a first embodiment of the computer-implemented model of a flexible document according to the invention;

FIG. 2 shows a perspective view of a first detail of the plurality of rigid parallelepiped-shaped bodies connected to each other in FIG. 1b;

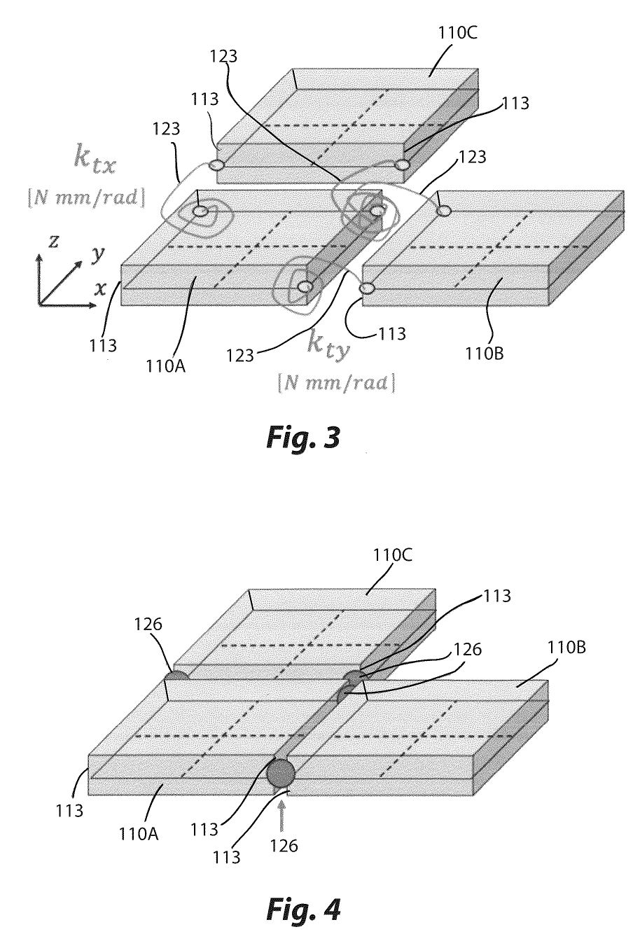

FIG. 3 shows a perspective view of a second detail of the plurality of rigid parallelepiped-shaped bodies connected to each other in FIG. 1b;

FIG. 4 shows a perspective view of a third detail of the plurality of rigid parallelepiped-shaped bodies connected to each other in FIG. 1b;

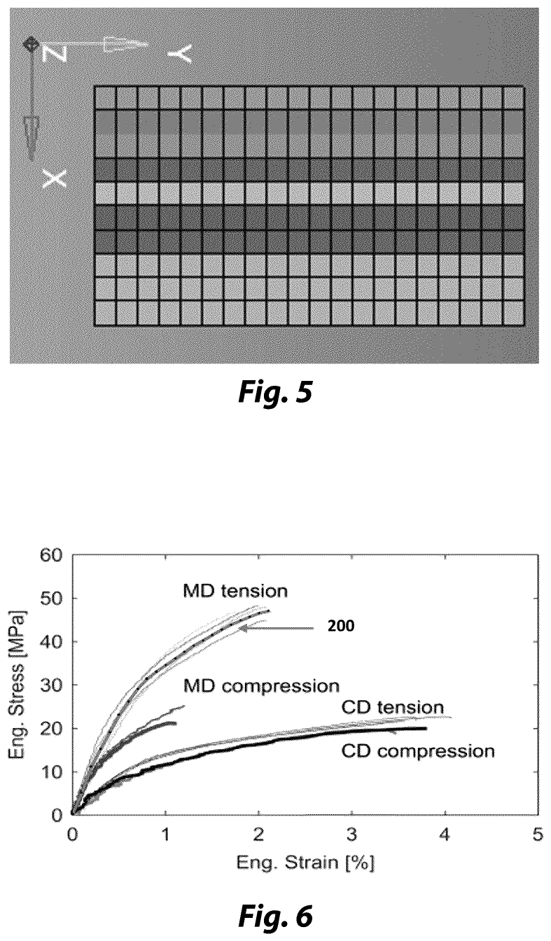

FIG. 5 shows a plan view of a 10 euro banknote decomposed into 200 rigid bodies according to the preferred embodiment of the computer-implemented model of a flexible document according to the invention;

FIG. 6 shows the fitting of the stress-strain curves of the paper in the MD direction;

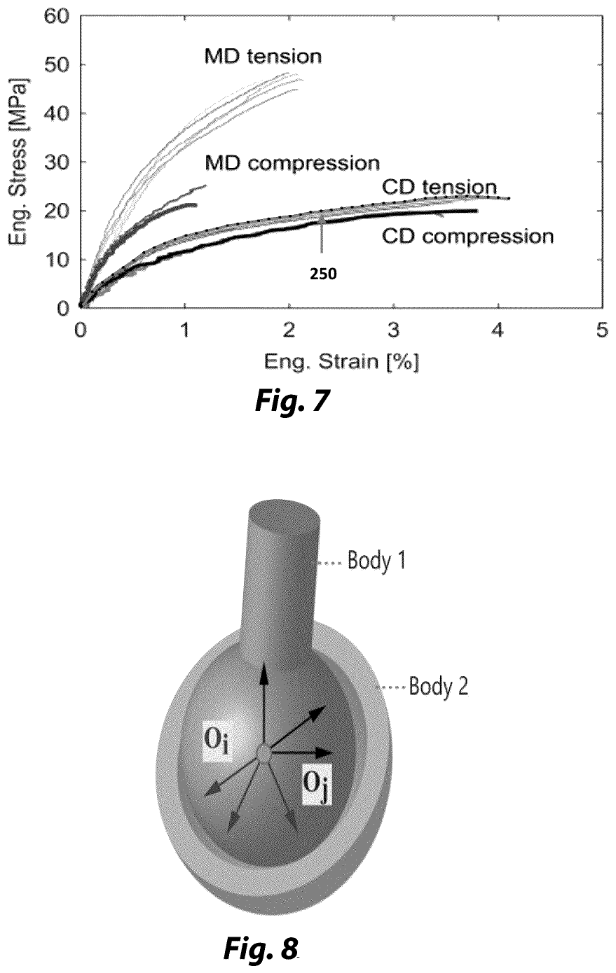

FIG. 7 shows the fitting of the stress-strain curves of the paper in the CD direction;

FIG. 8 schematically shows a connecting ball joint of the preferred embodiment of the computer-implemented model of a flexible document according to the invention;

FIG. 9 shows a first Contour diagram of a MultiBody model of the banknote in FIG. 5;

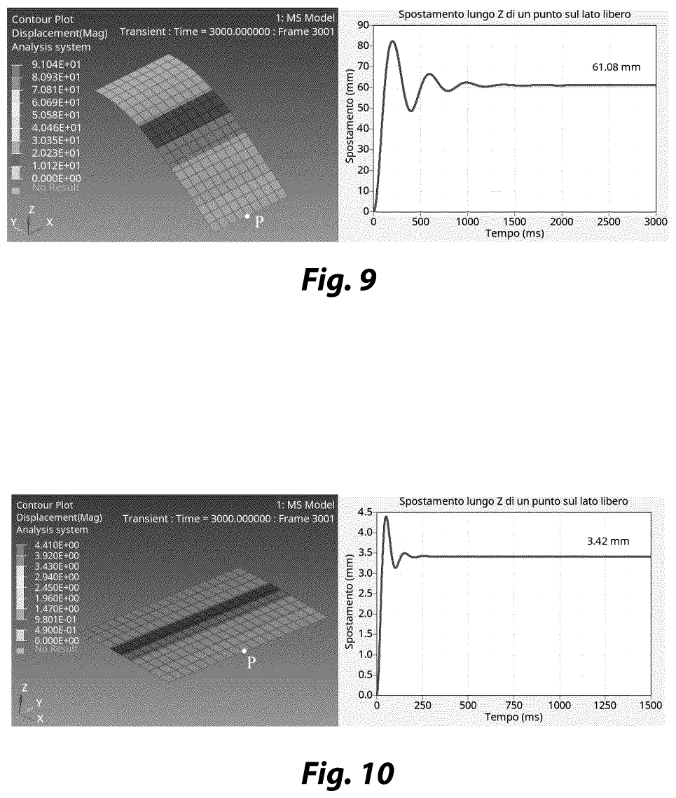

FIG. 10 shows a second Contour diagram of a MultiBody model of the banknote in FIG. 5;

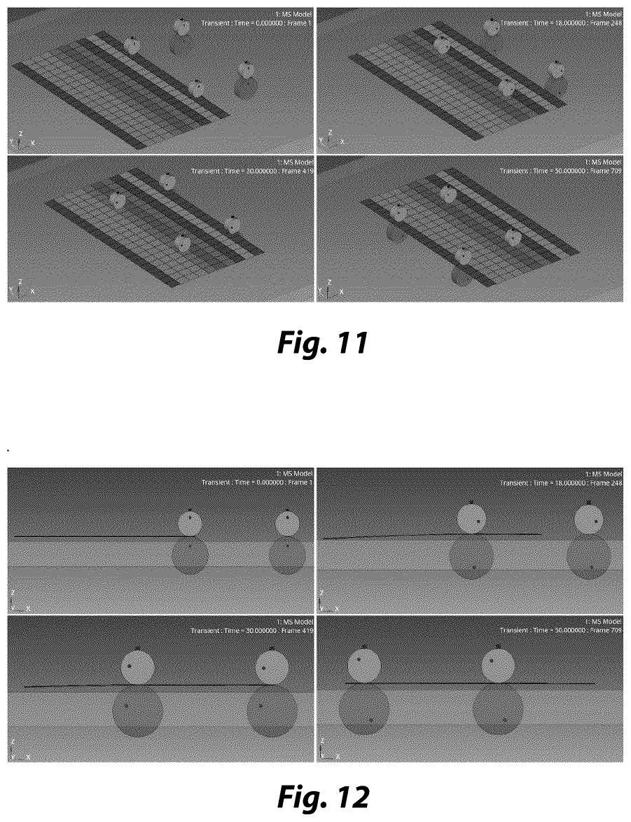

FIG. 11 shows four perspective view frames resulting from a simulation with a first MultiBody model;

FIG. 12 shows four side view frames corresponding to those in FIG. 11;

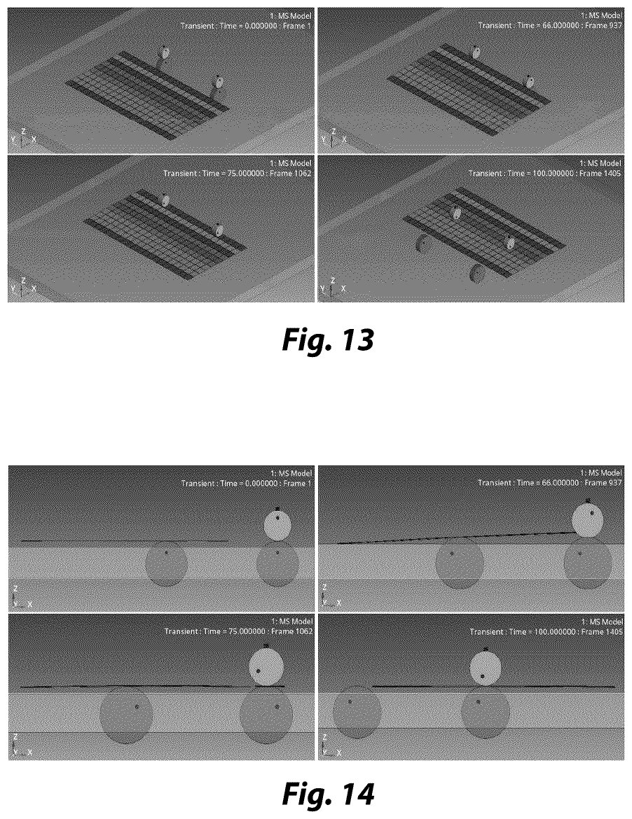

FIG. 13 shows four perspective view frames resulting from a simulation with a second MultiBody model;

FIG. 14 shows four side view frames corresponding to those in FIG. 13;

FIG. 15 shows four perspective view frames resulting from a simulation with a third MultiBody model; and

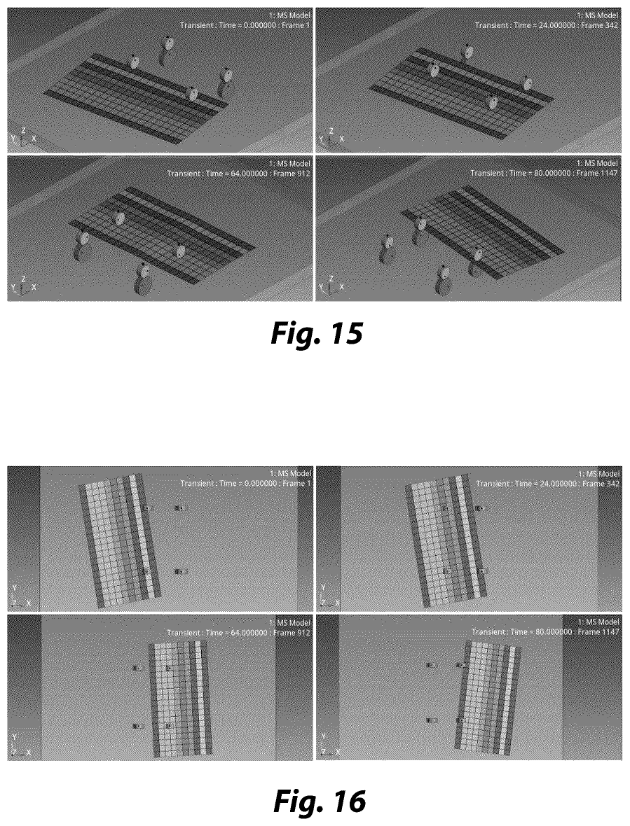

FIG. 16 shows four side view frames corresponding to those in FIG. 15.

In the Figures, identical reference numbers are used to indicate similar elements.

Banknotes in circulation today can be made of different materials, such as paper or polymer. In particular, polymer banknotes are used in some countries such as Australia and Canada, while in the member countries of the European Union banknotes are made of paper, such as euro banknotes. What is illustrated below for paper banknotes also applies to polymer banknotes and other flexible documents made of flexible materials.

The paper for euro banknotes is made of 100% cotton fibres, similar to other security papers such as stamps and bank cheques; in particular, for such documents, which must be kept for a long time, the paper is usually produced using pulps made from cotton, flax and hemp plants. This gives it a special consistency and resistance to wear to withstand being passed from hand to hand, unlike other types of paper. In particular, paper is a material made up of millions of plant fibres, i.e. cellulose fibres. The paper used in banknotes also includes several levels of security such as: watermark, i.e. images produced by varying the thickness of the paper; security thread; holograms; and embossing. This makes the banknotes reliable and difficult to counterfeit.

It is evident that the material from which the banknotes are made is very complex to model due to the numerous and complex security layers added, which cause its properties to vary across the entire surface.

There are several researches known in literature on the characterization of paper and cardboard, made by superposition of several layers of paper joined by an adhesive, such as the one described by Li et al. in ‘Anisotropic elastic plastic deformation of paper: In-plane model’, International Journal of Solids and Structures, Volumes 100-101, 2016, pp. 286-296, in which tests are performed on laminated cardboard samples to obtain the stress-strain curves of the paper. These curves were used to derive the stiffness values in the modeling of the banknote body according to the present invention.

The present invention uses a MultiBody approach to simulate banknote transport, first in some simple models and then in the more complex system represented by the initial part of the banking automation machine, i.e. in the sheet feeder. A MultiBody system consists of a set of bodies, rigid or flexible, connected by joints that limit their relative movement, and subjected to forces and motions applied to the different components of the system. Examples of MultiBody systems can be cars, trains, airplanes, industrial robots, washing machines, printers. Common to all these systems is that they involve large displacements: the relative motion between the components of the system is comparable to the dimensions of the overall system.

In general, any system can be decomposed into smaller, simpler subsets, which in turn consist of individual components, all the way down to atoms and molecules. Component-level simulation is often done using the Finite Element Method (FEM), where a detailed analysis of individual components, where small displacements occur, is performed. For system-level simulation, a MultiBody approach is used, which focuses on the behavior of the entire system, where large displacements characterize that behavior.

MultiBody or MBS (MultiBody Simulation) are generally long-lasting (a few seconds), while finite element analyses or FEA (Finite Element Analysis) are shorter. The size of the models also varies: a large MultiBody model can contain thousands of equations, while a large FE model can contain millions of equations. Due to the differences in model size and simulation requirements, the numerical methods used in FEA and MBS are significantly different.

The path of the banknote in a part of the mechanized transport machine can be a few tens of centimeters. Once a working and realistic banknote model has been created, by making some simplifications, it is possible to simulate the banknote transport in different applications. The invention is based on the MultiBody approach that allows to examine how the banknote body behaves in a larger system, namely the mechanized transport machine in which it is transported.

HyperWorks® from the American multinational Altair Engineering Inc. was used in the development of the invention. The MotionView® software was used to build the MultiBody models (pre-processing), the MotionSolve® solver was used for the analysis, and HyperView® and HyperGraph® were used for the visualization of the results (post-processing).

MultiBody model can be saved as a MDL (Model Definition Language) file, which contains information about all the entities contained in the model itself. MDL files are saved in ASCII format and can be opened and edited with a common text editor. This feature allows you to build models with thousands of entities in an automated way.

Once the model is built, the input file for the solver, which in the case of MotionSolve® is based on the XML standard, is exported. The XML file contains both the model information and the simulation to be performed, e.g. type of analysis and simulation time.

MultiBody model in MotionView® contains all the information to describe a mechanical system, including the loads and applied motions. This information is represented in the form of entities. An entity is an object that describes elements such as points, vectors, rigid bodies, joints, springs, forces, and motions.

As for the types of entities that can be contained in a model in MotionView®, generally you start from basic entities such as points and bodies (Reference Entity), possibly adding graphic elements, and then assign constraints (Constraint) and loads (Force Entity). The properties of the different entities can be parameterized as a function of variables (Control Entity), or you can use sensors to decide the response of an entity after the occurrence of a certain event. Finally, it is possible to create output requests (General MDL Entity) for post-processing, such as the measurement of position between two bodies or the forces that they exchange.

Every entity has properties. For example, the point entity needs the x, y, z coordinates to be defined, just as a body has mass and inertia properties. In particular, a property can be either a scalar value or a mathematical expression that makes it a function of other variables; the invention exploits this possibility to parameterize the banknote model.

In MotionView® entities are always enclosed in a system, which is nothing more than a container. A system can group both entities and other systems, according to a hierarchical organization. In particular, grouping entities into systems allows certain operations to be performed on all the entities contained in it, for example the system can be deactivated, i.e. it is not passed to the solver which therefore does not take it into account in the simulation, as well as performing a simultaneous translation of all the elements of a system through the translation of the system; otherwise, rotation is not allowed. The preferred embodiments of the invention exploit the MotionView® hierarchy to create a “Banknote” system that includes all the entities necessary for its creation, as well as different systems for creating contacts.

As mentioned, an MDL file is a text file in ASCII (American Standard Code for Information Interchange) format containing a structured list of MDL statements, i.e. declarations of typical MultiBody entities with a precise syntax. These entities can be of two types, namely:
General Entities, which have properties consistent with their nature; for example, a point has as properties the coordinates x, y, z, the identifying name (label), and the name of the variable (varname); and
Definition Based Entities, which are for example systems, analyses, datasets and templates, and which are constituted by a block of declarations, called definition, which can be initialized multiple times in a model; in particular, in the preferred embodiments of the invention the banknote is realized with rigid bodies with a set of systems whose initialization is done by importing the block of declarations directly from MotionView®.

To generate the entities that make up the MultiBody model, various MDL declarations are used, specifically:

Topology Statements, which define an entity and establish a topological relationship with another;

Set Statements, which assign properties to entities created by topology statements; and
Definition Statements, which are built on the concept of a definition block, include both topological and property declarations, and are generally used for entities such as systems, which are containers as illustrated above.

To write in a file with MDL extension all the entities that make up the MultiBody model, in the preferred embodiments of the invention the Python® programming language was used in the Visual Studio Code® environment, through which it is possible to automate the creation of large MultiBody models; in fact, one way to model the banknote is to generate many points and rigid bodies and this is possible thanks to the combination of MDL and Python® codes.

The invention is based on a flexible document model, which in the preferred embodiments is a banknote model, treated as a flexible body. In this regard, the banknote, considered to be made of paper material, is also deformed simply by bending it with the hands or by the effect of gravity; furthermore, it is precisely its flexibility that allows it to be transported in a mechanized transport machine. Furthermore, the invention takes into account the non-linear behavior of the material from which the banknote is made, in particular paper, so that the banknote model is flexible and non-linear.

As mentioned, the invention is based on the MultiBody simulation of a system consisting of rigid bodies. The treatment of flexible bodies and in particular the contacts involving them is carried out in the invention by means of an innovative technique that involves the decomposition of the banknote into rigid bodies in which flexibility is given through the connections of the same, allowing to overcome the limits of two conventional techniques, namely: the Linear Flexible Body technique that allows to consider only a linear behavior, and the Non Linear Finite Element Body (NLFE) technique that allows to model in a completely non-linear way elements that are substantially exclusively 1D (with the exception of specific rather complex applications having an ad hoc code). In particular, the MotionSolve® software, which is the Altair® MultiBody solver, supports both of these conventional techniques, and allows the implementation of the innovative technique on which the invention is based.

With reference to FIG. 1, it can be observed that in the preferred embodiments of the invention, applied to a 10 euro banknote, the banknote body 100 is decomposed into a plurality of rigid bodies 110, connected together by connecting elements which comprise or consist of:
connection springs having a rotational stiffness, and
a plurality of further three connection springs having translational stiffnesses representing flexible links 120 shown in FIG. 1c, in the first preferred embodiment, or alternatively ball joints, in the second preferred embodiment.

In the preferred embodiments, a series of codes have been written in Python® to implement the ‘banknote’ system to be inserted into the MultiBody model.

Although a rigid body, by definition, does not deform, to represent a flexible document such as a banknote the invention has transferred the flexibility of the latter from the ‘rigid body’ entities 110 to the ‘links’ entities represented by the connection springs, which in the first embodiment comprise connection springs having a rotational stiffness and further three connection springs having translational stiffnesses, while in the second embodiment comprise connection springs having a rotational stiffness, so that the material properties that give flexibility to the banknote are inserted in the connections between the different rigid bodies 110.

Referring also to FIG. 2, it can be observed that the banknote 100 is considered as a parallelepiped having a first dimension along a longitudinal direction, represented by the y-axis, and a second dimension along a transverse direction, represented by the x-axis, orthogonal to the longitudinal direction, and a thickness along a thickness direction, represented by the z-axis, orthogonal to both the longitudinal and transverse directions. It should be kept in mind that, since the thickness of the banknote is much less than the first dimension and the second dimension, e.g. equal to about 0.1 millimeters, the banknote 100 can be modeled with a single layer of rigid bodies 110; in other words, the 100 note is divided into a plurality of small parallelepipeds, i.e. the rigid bodies 110, where each rigid body has a longitudinal axis, a transverse axis orthogonal to the longitudinal axis, and a thickness axis orthogonal to both the longitudinal and transverse axes. When the flexible document, namely the 100 note, assumes an unfolded configuration, the longitudinal axis, the transverse axis and the thickness axis of each rigid body are respectively parallel to the longitudinal direction, the transverse direction and the thickness direction of the flexible document, i.e. respectively parallel to the y-axis, the x-axis and the z-axis represented in FIG. 2. In particular, FIG. 2 shows three adjacent rigid bodies indicated by the reference numerals 110A, 110B and 110C, respectively.

Even if modeled with a single layer of 110 rigid bodies, a higher discretization of the banknote 100, i.e. its subdivision into smaller 110 rigid bodies, leads to a better representation of the flexibility of the banknote 100, at the cost of significantly higher computation times, so it is advantageous to identify a compromise between the number of 110 rigid bodies into which to decompose the banknote 100 and the computation times needed to simulate its transportation. This number of 110 rigid bodies is selected based on the specific simulation that one wants to perform, adopting the minimum possible number in order to reduce the software computation times, but capturing the macroscopic behavior of the banknote 100.

The invention takes into account a connection system 120 between the rigid bodies 110 shaped like a parallelepiped into which the banknote 100 is divided, whereby each rigid body 110 is connected to all the rigid bodies 110 that are adjacent to it along both its longitudinal axis and its transverse axis. In particular, referring to FIG. 1b, each rigid body 110P along the perimeter of the banknote 100, with the exception of the four rigid bodies 110R at the corners of the banknote 100, is connected to three rigid bodies 110P_A adjacent to it along both the longitudinal axis and the transverse axis of the rigid body 110P; each of the four rigid bodies 110R at the corners of the banknote 100 is connected to two rigid bodies 110R_A adjacent to it along both the longitudinal axis and the transverse axis of the rigid body 110R; Each rigid body 110D within the perimeter of the 100 note is connected to four rigid covers 110D_A adjacent to it along both the longitudinal and transverse axes of the rigid body 110D.

In the first preferred embodiment of the invention, the connection system 120 between the rigid bodies 110 comprises connection springs schematically shown in FIG. 1c, by means of which each rigid body 110 is connected to all rigid bodies 110 adjacent to it along both its longitudinal axis and its transverse axis, the ends of which are connected to rigid body connection edges 113, shown in FIG. 2, which are parallel to the thickness z-axis of the respective rigid body 110; in particular, as will be illustrated in detail later, each connection edge 113 of each connected rigid body 110 is connected to a connection edge 113 of a rigid body adjacent to it by means of:
a first connection spring having a rotational stiffness about a rotation axis that is orthogonal to the thickness axis of the connected rigid body 110 and to the axis along which the connected rigid body 110 is connected to the adjacent rigid body, whereby the rotation axis is selected between the longitudinal axis and the transverse axis of the connected rigid body 110 and the first connection spring has a rotational stiffness k_{ty} or kₜₓ of rotation, respectively; such first connection springs, which are part of said connecting elements are schematically represented in FIG. 3 and indicated by the reference numbers 123; and
a connecting structure consisting of a set of further three connection springs consisting of a second connection spring having a stiffness k_{y} of translation along the longitudinal axis of the connected rigid body 110, a third connection spring having a stiffness kₓ of translation along the transverse axis of the connected rigid body 110, and a fourth connection spring having a stiffness k_{z} of translation along the thickness axis of the connected rigid body 110; whereby the further three connection springs are part of said connecting elements.
   Advantageously, each end of each connection spring is connected to a corresponding connecting edge of a respective rigid body at a mean plane which is parallel to both the longitudinal and transverse axes of the respective rigid body and on which lies a center of mass of the respective rigid body.

Furthermore, as will be illustrated in detail later, in the first preferred embodiment of the invention, each connection spring is accompanied by a respective connection damper, whereby each connection edge 113 of each connected rigid body 110 is connected to a connection edge 113 of a rigid body adjacent to it also by:
a first connection damper having a rotational damping factor about a rotational axis that is orthogonal to the thickness axis of said connected rigid body and to the axis along which the connected rigid body is connected to the adjacent rigid body, whereby the rotational axis is selected between the longitudinal axis and the transverse axis of the connected rigid body 110 and the first connection damper has a damping factor c_{ty} or cₜₓ of rotation, respectively, and
a set of three additional connection dampers consisting of a second connection damper having a factor c_{y} of translational damping along the longitudinal axis of the connected rigid body 110, a third connection damper having a cₓ translational damping factor along the transverse axis of the connected rigid body 110, and a fourth connection damper having a damping factor c_{z} of translation along the thickness axis of the connected rigid body 110.

Advantageously, each end of each connecting damper is connected to a corresponding connecting edge of a respective rigid body on the midplane of the respective rigid body and on which lies a center of mass of the respective rigid body.

As mentioned, since the thickness of the banknote is much less than the first dimension and the second dimension, the banknote can be modeled with a single layer of rigid bodies 110.

To the rigidity k_{z} of translation of the fourth spring along the thickness axis of the connected rigid body 110 can be assigned a very high value, at least equal to 1,000 N/mm, optionally at least equal to 10,000 N/mm.

It should be noted that in other embodiments, the flexible document may be modeled with two or more layers each of which is decomposed into a respective plurality of rigid bodies, wherein each connecting edge 113 of each rigid body 110 of a layer is connected to a connecting edge 113 of a rigid body adjacent to it along the thickness axis, i.e. of an adjacent rigid body but belonging to another layer, by means of a thickness connection spring having a translational stiffness along the thickness axis which is a function of the stiffness, i.e. of the resistance, along the thickness axis of the material from which the banknote 100 is made; typically, such translational stiffness along the thickness axis is assigned a value sufficiently high to faithfully represent the behavior of the flexible document.

It should also be noted that in further embodiments, the stiffness k_{z} of translation of every fourth spring along the thickness axis can be assigned values less than 1.000 and comparable to those assigned to the stiffnesses kₓ and k_{y} of translation along the transverse axis and along the longitudinal axis, respectively, of the connected rigid body 110.

The translational stiffness values are obtained from the stress-strain curves of the material from which the banknote 100 is made, specifically the stress-strain curves of the paper. A manual fitting is performed with a series of points so as to follow on average the MD tension curves, obtained from a tensile test of the paper in the MD (Machine Direction) direction, and the CD tension curves, obtained from a tensile test in the CD (Cross Direction) direction, in which the MD direction is the direction in which the fibres in the sheet of paper align and compact in the continuous machine in which the transformation of the pulp into paper begins and the CD direction is the direction orthogonal to the MD direction.

As an example, and not as a limitation, in the case of a 10 euro banknote, the first dimension along the longitudinal direction is 127 millimeters, the second dimension along the transverse direction is 67 millimeters, and a thickness of 0.1 millimeters, and the 10 banknote is split into a single layer of 10×20 rigid bodies as shown in FIG. 5. Since the MD direction coincides with the transverse direction, i.e. the x-axis, the kₓ translational stiffness along the transverse axis of the third connection springs is obtained from the fitting of the MD tension curves, while the translational stiffness along the longitudinal axis of the second connection springs is obtained from the CD k_{y} tension curves. Table 1 reports the geometric and mass quantities for the 10 euro banknote decomposed into 200 boxes as shown in FIG. 5.

TABLE 1
10 euro banknote

| | | |
|---|---|---|
| Surface density [g/m²] | ρ | 85 |
| Banknote mass [g] | M | 0.72 |
| Length long x [mm] | Lₓ | 67 |
| Length along y [mm] | L_{y} | 127 |
| Thickness [mm] | s | 0.1 |
| Number of rigid bodies along x | nₓ | 10 |
| Number of rigid bodies along y | n_{y} | 20 |
| Rigid body length along X [mm] | dₓ | 7.44 |
| Rigid body length along Y [mm] | d_{y} | 6.68 |
| Mass of a rigid body [g] | m | 0.0036 |

To define the quantities needed to calculate the stiffness, the following formulas are generally used:

$${d}_{x} = {L}_{x} / ( {n}_{x} - 1 )$$

$${d}_{y} = {L}_{y} / ( {n}_{y} - 1 )$$

where these lengths coincide with the distances between the centers of mass of adjacent rigid bodies along x and y, which are equally spaced,

$$m = M / ( {n}_{x} \cdot {n}_{y} )$$

and the sections Aₓ and A_{y} of each rigid body 110 with normal respectively to the transverse axis, i.e. to the x-axis, and to the longitudinal axis, i.e. to the y-axis, are obtained as follows:

$${A}_{x} = {d}_{y} \cdot s$$

$${A}_{y} = {d}_{x} \cdot s$$

The elastic modulus E, which is the last parameter needed for calculating the translational stiffnesses, is obtained from the stress-strain curves of the paper.

FIG. 6 shows the fitting 200 of the stress-strain ε curves σ of the paper in the MD direction; for each pair of points σ-ε the elastic modulus is calculated E according to Hooke's law:

$$E = σ / ε$$

The strain, stress and elastic modulus values E obtained from fitting 200 are reported in Table 2.

TABLE 2
Traction curve in MD direction

| values obtained from the | | | values obtained from the | | |
|---|---|---|---|---|---|
| fitting | | | fitting | | |
| deformation | stress | And | deformation | stress | And |
| [%] | [MPa] | [MPa] | [%] | [MPa] | [MPa] |
| 0 | 0 | 0 | 1.1 | 36 | 3272.73 |
| 0.1 | 5 | 5000.00 | 1.2 | 37.5 | 3125.00 |
| 0.2 | 11 | 5500.00 | 1.3 | 39 | 3000.00 |
| 0.3 | 15 | 5000.00 | 1.4 | 40.2 | 2871.43 |
| 0.4 | 19 | 4750.00 | 1.5 | 41.5 | 2766.67 |
| 0.5 | 23 | 4600.00 | 1.6 | 42.7 | 2668.75 |
| 0.6 | 26 | 4333.33 | 1.7 | 43.8 | 2576.47 |
| 0.7 | 29 | 4142.86 | 1.8 | 44.8 | 2488.89 |
| 0.8 | 31.3 | 3912.50 | 1.9 | 45.7 | 2405.26 |
| 0.9 | 33 | 3666.67 | 2 | 46.5 | 2325.00 |
| 1 | 34.5 | 3450.00 | 2.1 | 47 | 2238.10 |

Translational stiffness kₓ along the transverse axis of the corresponding rigid body of the third connection springs is obtained from Hooke's law:

$$σ = E ε = F / A = ( k Δ L ) / A$$

where the engineering strain is defined as:

$$ε = Δ L / {L}_{0}$$

which leads to:

$$E Δ L / {L}_{0} = k Δ L / A$$

so the translational stiffness in the MD direction is given by:

$$k = E A / {L}_{0}$$

In the first preferred embodiment of the invention, for simplicity, an average value of the Young's modulus is assumed, thus obtaining a constant value of the translational stiffness. Other embodiments of the invention can assign a point curve to the translational stiffness of the translational springs, e.g. by using the possibilities provided by MotionView®.

Since the MD direction coincides with the x-axis, that is, with the transverse axis of the rigid bodies 110 into which the banknote 100 is divided, the stiffnesses calculated using the curve in the MD direction refer to the translation stiffness kₓ along the transverse axis of the rigid bodies 110 of the third connection springs:

$${k}_{x} = {E}_{MD} {A}_{x} / {d}_{x}$$

where E_{MD} is the average value of the elastic modulus obtained from Table 2; in the illustrated example of the 10 euro banknote, we have:

$${k}_{x} = 3528 \cdot 0.6684 / 7.444 = 317 N / mm$$

As already mentioned above, in the first preferred embodiment of the invention, each connection spring is accompanied by a respective connection damper. In the example of the 10 euro banknote, the cₓ translation damping factor along the transverse axis of the corresponding rigid body 110 of the third connection dampers is obtained from the mass and stiffness information according to the formula obtainable from the dynamic study of a mass-spring-damper system:

$$2 ζ {ω}_{n} = c / m$$

$$c = 2 ζ m \sqrt{k / m}$$

$$c = 2 ζ \sqrt{k \cdot m}$$

where ζ is the relative damping coefficient and depends on the material, k is the stiffness, and m is the mass of a rigid body 110. The ζ relative damping coefficient can be obtained, for example, on the basis of experimental measurements and with the logarithmic decrement method. In the example illustrated, a relative damping coefficient equal to 12% was chosen ζ; in fact, starting from the assumption that paper has a greater damping than steel, for which one could assume a variable coefficient in the range 3%-5%, and that wooden structures, to which paper that is produced from wood belongs, have variable coefficients in the range 15%-20%, considering the geometry of the banknote and that the MD direction coincides with the x-axis, the value of 12% is certainly reliable. Consequently, the translational damping factor cₓ along the transverse axis of the third connecting dampers between adjacent rigid bodies 110 is equal to:

$${c}_{x} = 2 ζ \sqrt{{k}_{x} \cdot m}$$

from which it is obtained

$${c}_{x} = 0.26 N / ( mm / ms )$$

Similarly to what has been illustrated for the determination of the kₓ translational stiffness along the transverse axis of the third connection springs, for the k_{y} translational stiffness along the longitudinal axis of the second connection springs, the fitting, shown in FIG. 7 with the reference number 250, of the stress σ-strain curves ε of the paper in the CD direction is performed, i.e. the fitting of the CD tension curves. The values of strain, stress and elastic modulus E obtained from fitting 250 are reported in Table 3.

TABLE 3
Traction curve in CD direction

| values obtained | | | values obtained | | | values obtained | | |
|---|---|---|---|---|---|---|---|---|
| from the fitting | | | from the fitting | | | from the fitting | | |
| deformation | stress | And | deformation | stress | And | deformation | stress | And |
| [%] | [MPa] | [MPa] | [%] | [MPa] | [MPa] | [%] | [MPa] | [MPa] |
| 0 | 0 | 0 | 1.4 | 16.5 | 1178.57 | 2.8 | 20.8 | 742.86 |
| 0.1 | 3 | 3000.00 | 1.5 | 16.9 | 1126.67 | 2.9 | 21 | 724.14 |
| 0.2 | 5 | 2500.00 | 1.6 | 17.2 | 1075.00 | 3 | 21.2 | 706.67 |
| 0.3 | 6.5 | 2166.67 | 1.7 | 17.5 | 1029.41 | 3.1 | 21.4 | 690.32 |
| 0.4 | 8 | 2000.00 | 1.8 | 17.9 | 994.44 | 3.2 | 21.7 | 678.13 |
| 0.5 | 9.5 | 1900.00 | 1.9 | 18.2 | 957.89 | 3.3 | 22 | 666.67 |
| 0.6 | 11 | 1833.33 | 2 | 18.5 | 925.00 | 3.4 | 22.2 | 652.94 |
| 0.7 | 12 | 1714.29 | 2.1 | 18.8 | 895.24 | 3.5 | 22.3 | 637.14 |
| 0.8 | 13 | 1625.00 | 2.2 | 19.2 | 872.73 | 3.6 | 22.4 | 622.22 |
| 0.9 | 13.7 | 1522.22 | 2.3 | 19.5 | 847.83 | 3.7 | 22.5 | 608.11 |
| 1 | 14.5 | 1450.00 | 2.4 | 19.7 | 820.83 | 3.8 | 22.4 | 589.47 |
| 1.1 | 15 | 1363.64 | 2.5 | 20 | 800.00 | 3.9 | 22.3 | 571.79 |
| 1.2 | 15.5 | 1291.67 | 2.6 | 20.3 | 780.77 | 4 | 22.2 | 555.00 |
| 1.3 | 16 | 1230.77 | 2.7 | 20.5 | 759.26 | 4.1 | 22.1 | 539.02 |

Since the CD direction coincides with the y-axis, that is, with the longitudinal axis of the rigid bodies 110 into which the banknote 100 is divided, the stiffnesses calculated using the curve in the CD direction refer to the translation stiffness k_{y} along the longitudinal axis of the rigid bodies 110 of the second connection springs:

$${k}_{y} = {E}_{CD} {A}_{y} / {d}_{y}$$

where E_{CD} is the average value of the elastic modulus obtained from Table 3; in the illustrated example of the 10 euro banknote, we have:

$${k}_{y} = 1113 \cdot 0.7444 / 6.684 = 124 N / mm$$

For the c_{y} translational damping factor along the longitudinal axis of the corresponding rigid body 110 of the second connection dampers, still assuming a relative damping coefficient ζ of 12%, we obtain:

$${c}_{y} = 2 ζ \sqrt{{k}_{y} \cdot m}$$

$${c}_{y} = 0.16 N / ( mm / ms )$$

As mentioned, the rigidity k_{z} of translation along the thickness axis of the connected rigid body 110 can be assigned a very high value, at least equal to 1,000 N/mm, optionally at least equal to 10,000 N/mm; in this case, the c_{z} translation damping factor along the thickness axis is assigned a value of at least equal to 0.4553 N/(mm/ms), optionally equal to 1.44 N/(mm/ms), which is again calculated on the basis of the respective translation stiffness, i.e. on the basis of the k_{z} translation stiffness along the thickness axis and the relative damping coefficient, assumed to be equal to 12% ζ.

In the illustrated example of the 10 euro banknote, the stiffnesses k_{ty} and kₜₓ of rotation around the rotation axes that are orthogonal, in addition to the thickness axis of the rigid body, also to the longitudinal axis and the transverse axis, respectively, of the rigid body, experimental tests have been carried out.

In particular, to determine the stiffness kₜₓ of rotation around the rotation axis which is orthogonal, in addition to the thickness axis of the rigid body, also to the transverse axis of the rigid body, a test was performed by keeping the short side of the 100 euro banknote, indicated with 101 in FIG. 1a, fixed and letting the banknote fall by gravity. The displacement of the free short side, i.e. the opposite short side indicated with 102 in FIG. 1a, was then measured with a probe; alternatively, it is also possible to perform a force-displacement measurement test by applying loads of a few grams. The displacement of the free short side 102 experimentally measured was equal to 60.76 millimeters.

MultiBody model that reproduces the experimental condition consists of the banknote 100 decomposed into 200 rigid bodies with fixed joints on one of the short sides. The connection springs that act in this condition are the first 123 connection springs having stiffnesses kₜₓ of rotation around an axis of rotation coinciding with the transverse axis of the rigid body. FIG. 9 shows the Contour diagram relating to a deformable surface attached to the rigid bodies 110; in particular, the inventors have carried out various tests by changing the value of the stiffness kₜₓ of rotation around the transverse axis of the rigid body until obtaining the experimentally measured displacement and the result visible in FIG. 9.

Moreover the value of factor cₜₓ of rotational damping around the transverse axis of the rigid body was determined so as to obtain approximately the same number of bounces that the banknote 100 performs in reality when dropped, taking into account the errors in the experimental measurement and the non-perfect equality with the simulation from the point of view of the space corresponding to the short side 101 of the effectively fixed banknote 100, this depending on the dimensions of the rigid bodies 110, in order to simulate as faithfully as possible the real behavior of the banknote 100.

Assigning the value of 0.15 N·mm/rad to the stiffness kₜₓ of rotation around the transverse axis of the rigid body, a simulated displacement of the free side 102 of the banknote 100 equal to 61.08 mm is obtained, which can be considered acceptable. Still assuming a relative damping coefficient equal to 12% ζ, it was obtained that the factor cₜₓ of rotational damping about the transverse axis of the rigid body is equal to 5.58 N·mm·ms/rad for the corresponding first connection dampers between adjacent rigid bodies.

As illustrated above to determine the stiffness kₜₓ of rotation around the transverse axis of the rigid body was also done to determine the stiffness k_{ty} of rotation around the rotation axis which is orthogonal, in addition to the thickness axis of the rigid body, also to the longitudinal axis of the rigid body, coinciding in the example with the y-axis. In particular, a test was carried out by keeping the long side of the 10 euro banknote 100 fixed, indicated with 103 in FIG. 1a, and by letting the banknote fall due to gravity. The displacement of the free long side, i.e. the opposite long side indicated with 104 in FIG. 1a, was then measured, which was equal to 3.44 millimetres.

MultiBody model that reproduces the experimental condition consists of the banknote 100 decomposed into 200 rigid bodies with fixed joints on one of the long sides. The connection springs that act in this condition are the first 123 connection springs having stiffnesses k_{ty} of rotation around an axis of rotation coinciding with the longitudinal axis of the rigid body. FIG. 10 shows the Contour diagram relating to a deformable surface attached to the rigid bodies 110; in particular, the inventors have carried out various tests by changing the value of the stiffness k_{ty} of rotation around the longitudinal axis of the rigid body until obtaining the experimentally measured displacement and the result visible in FIG. 10.

Assigning the value of 0.185 N·mm/rad to the stiffness k_{ty} of rotation around the longitudinal axis of the rigid body, a simulated displacement of the free side 104 of the banknote 100 equal to 3.42 mm is obtained, which can be considered acceptable. Considering the geometry of the banknote 100 and the experimental arrangement in which the banknote is fixed by one of the long sides, a relative damping coefficient equal to 4% ζ can be assumed, thus obtaining that the factor c_{ty} of rotational damping about the longitudinal axis of the rigid body is equal to 2.06 N·mm·ms/rad for the corresponding first connection dampers between adjacent rigid bodies.

In particular, the connection between adjacent rigid bodies in MotionView® is performed using the ‘Bushing’ entity which allows you to insert translational and rotational stiffnesses and related damping.

In the first preferred embodiment of the invention, each rigid body is connected to all rigid bodies adjacent to it along both its longitudinal axis and its transverse axis by a plurality of connection springs and a corresponding plurality of connection dampers. It should be noted, however, that other embodiments of the computer-implemented model of a flexible document according to the invention may have each rigid body connected to all rigid bodies adjacent to it along both its longitudinal axis and its transverse axis only by a plurality of connection springs, or only by a plurality of connection springs and a corresponding plurality of connection dampers, always remaining within the scope of protection of the present invention as defined by the appended claims.

In the first preferred embodiment of the invention, all first connection springs have the same value of stiffness kₜₓ or k_{ty} rotation about the rotation axis selected between the longitudinal axis and the transverse axis of the rigid bodies 110, all second connection springs have the same value of k_{y} translational stiffness along the longitudinal axis of the rigid bodies 110, all third connection springs have the same value of kₓ translational stiffness along the transverse axis of the rigid bodies 110, all fourth connection springs have the same value of k_{z} translational stiffness along the thickness axis of the rigid bodies 110, all first connection dampers have the same value of rotational damping factor cₜₓ about c_{ty} the rotation axis selected between the longitudinal axis and the transverse axis of the rigid bodies 110, all second connection dampers have the same value of cₓ translational damping factor along the longitudinal axis of the rigid bodies 110, all third connection dampers have the same c_{y} translational damping factor value along the longitudinal axis of the rigid bodies 110, and all fourth connection dampers have the same c_{z} translational damping factor value along the thickness axis of the rigid bodies 110. It should however be borne in mind that further embodiments of the computer-implemented model of a flexible document according to the invention may have first connection springs having rotational stiffness values around a homologous rotation axis that are different from each other at least for some of the connections between adjacent rigid bodies, and/or second connection springs having translational stiffness values that are different from each other at least for some of the connections between adjacent rigid bodies, and/or third connection springs having translational stiffness values that are different from each other at least for some of the connections between adjacent rigid bodies, and/or fourth connection springs having translational stiffness values that are different from each other at least for some of the connections between adjacent rigid bodies, and/or first connection dampers having rotational damping factor values around a homologous rotation axis that are different from each other at least for some of the connections between adjacent rigid bodies, and/or second connection dampers having translational damping factor values that are different from each other at least for some of the connections between adjacent rigid bodies, and/or third connection dampers having translational damping factor values different from each other at least for some of the connections between adjacent rigid bodies, and/or fourth connection dampers having translational damping factor values different from each other at least for some of the connections between adjacent rigid bodies, always remaining within the scope of protection of the present invention as defined by the appended claims.

Alternatively to the set of three additional connection springs, in the second preferred embodiment of the invention the connection structure between adjacent rigid bodies 110 consists of connecting ball joints, whereby each rigid body 110 is connected to all rigid bodies adjacent to it along both its longitudinal axis and its transverse axis by means of a plurality of connecting ball joints, wherein each connecting edge 113 of each rigid body 110 is connected to a connecting edge 113 of a rigid body adjacent to it by means of a respective connecting ball joint; such connecting ball joints, which are part of the connecting elements of the adjacent rigid bodies, are schematically represented in FIG. 4 and indicated by the reference numbers 126. Advantageously, each connecting ball joint is connected to corresponding connecting edges of respective rigid bodies adjacent to each other on the mean plane of each of the respective rigid bodies. In this case, relative translations between adjacent rigid bodies 110 are not allowed.

In other words, in the second preferred embodiment of the computer-implemented model of a flexible document according to the invention, as shown in FIG. 4, each rigid body 110 is connected to all rigid bodies that are adjacent to it along both its longitudinal axis and its transverse axis also by means of a plurality of connecting spherical joints 126, wherein each connecting edge 113 of each rigid body 110 is connected to a connecting edge 113 of a rigid body adjacent to it by means of a respective connecting spherical joint 126, schematically represented in FIG. 8.

A ball joint eliminates the three degrees of translational freedom, allowing only relative rotation between two bodies via the first connection springs 123. The joints 126 act as a hinge between a rigid body 110 and another adjacent to it, making the banknote 100 infinitely rigid for translations along the three axes. This is justified by the fact that the banknote substantially does not undergo tensile stresses during transport, but only bending stresses; therefore, it may still be acceptable to neglect the axial deformations. Consequently, since relative translations between two connected rigid bodies are not permitted, it no longer makes sense to impose values on the translational stiffnesses kₓ, k_{y} and k_{z}.

The technique of breaking down the banknote 100 into at least one layer comprising a plurality of rigid bodies 110 according to the invention offers complete control over the model implemented by means of a banknote processor, or other flexible document, and the possibility of assigning non-linear curves to the connection springs. In MotionView® there is no automatic operation to create the banknote composed of a desired number of points, rigid bodies, graphic elements, bushings and spherical joints. It is possible to import a text or excel file with a table containing the coordinates of the points, but these would then remain fixed in space since the coordinates are represented by numbers and not by variables. Furthermore, it is only possible to translate a system in MotionView®, but not to rotate it. In the case of creating the points automatically, it would then be necessary to create the rigid bodies, and connect them together with the bushings. This operation is not feasible with the pre-processor, selecting each entity with the mouse, since the model implemented by the banknote processor according to the invention, which can be called as ‘Banknote’ system, is made up of hundreds or thousands of entities.

The inventors have automated the creation of the banknote model using the MDL and Python® languages. In fact, the MDL language allows you to write the entities to be inserted in a MultiBody model in a text file and it is therefore possible to convert mouse click operations into letters and numbers, while the creation of repetitive lines of text is automated with the Python® programming language. In particular, each Python® code writes the information that is commanded in a text file and assigns the MDL extension to this file, which allows the file to be imported into MotionView® to create the entities.

Table 4 lists the Python® codes developed by the inventors to realize the MultiBody model of the banknote:
the code ‘cloud_points.py’ generates the points at the center and corners of each rigid body 110 on the midplane and the rigid bodies 110 with mass and inertia properties;
the code ‘box_graphics.py’ creates the graphic elements to be associated with each rigid body 110, creating a rigid body shaped like a parallelepiped; in particular, these graphic elements have the purpose of post-processing visualization and also play a fundamental role in defining the contacts;
the code ‘bushings.py’ creates the connection entities between all rigid bodies, i.e. the bushings;
The code ‘ball_joints.py’ creates the ball joints at the connecting edges 113 of each rigid body 110.
   Additionally, Table 4 lists the code ‘deformable_surface.py’, which is an optional code that creates a deformable surface that attaches to each 110 rigid body at its center point on the midplane when you want to display results in your simulation that would otherwise not be possible with 110 rigid bodies alone.

TABLE 4

| Codes in Python | Entities created | Output MDL file |
|---|---|---|
| cloud_points.py | points and rigid | cloud_points.mdl |
| | bodies | |
| box_graphics.py | graphic elements | box_graphics.mdl |
| | (box) | |
| bushings.py | connection entity | bushings.mdl |
| | (bushing) | |
| ball_joints.py | ball joints | ball_joints.mdl |
| deformable_surface.py | deformable surface | deformable_surface.mdl |

All codes listed in Table 4 have in common the entity nomenclature to correctly define the connections between rigid bodies 110.

A discretization of a flexible document with 40 rigid bodies along the x-axis and 70 rigid bodies along the y-axis leads to a total number of 2800 rigid bodies, and already with this number the pre-processing phase slows down considerably. Thanks to the well-defined nomenclature common to all entities, it is easy, for example, to connect the 110 rigid bodies with your graphic element, connect two successive rigid bodies along the x-axis and two successive rigid bodies along the y-axis.

All the characteristic quantities of the entities that make up the banknote 100 have been parameterized with variables. For example, it is possible to change the mass of the banknote, and therefore that of all the rigid bodies, by modifying the relative variable, just as it is possible to change the values of the rigidity of the bushings.

To define the position of the banknote in the model, it is necessary to define the coordinates of the points that are the centers of mass of the rigid bodies that compose it. The coordinates of these points have been parameterized both for translation along the x, y and z axes, and for rotation. MotionView® only allows translation of the entities enclosed in a system, while no rotation is possible. This limitation has led to the development of the coordinates of the points with functions and not with constant numerical values. In particular, the inventors have defined as the ‘starting point’, with respect to which to parameterize all the other points, the first point of the banknote, that is, the center of mass of the body on the first row and first column. This point has the coordinates defined with respect to the origin of the global reference system and represents the point through which the z-axis passes, an axis around which a rigid rotation of all the other points can be performed.

In this regard, the parameterization allows to adjust the position of the banknote via the MotionView® graphical interface, without the need for any modification to the Python® codes.

The invention is also based on an innovative approach to model the contacts between the banknote, or other flexible document, and the elements of the banknote transport machine, or other flexible documents. In particular, this is possible with the MotionSolve® software, and modeling the banknote by breaking it down into a plurality of rigid bodies connected by springs and joints necessarily requires contact between rigid bodies, represented by the entity ‘3D Rigid to Rigid Contact’. In more detail, the approach used in the invention is the contact between rigid bodies which is simple to apply, given the simplified and ideal nature of a real body represented as a rigid body, i.e. non-deformable. Each rigid body can be associated with one or more geometries, which represent its presence in 3D space. When the geometries of two rigid bodies interpenetrate, contact occurs and the forces that the two bodies exchange are calculated, for example via MotionSolve®.

In this regard, in addition to the more general contact between 3D rigid bodies, it is also possible to model the contact between 2D rigid bodies, i.e. between two geometries that lie on a plane, such as two closed curves. An application of the 2D contact between rigid bodies is the simplification of the contact between two cylinders, whose geometries can be represented by circles. In this way the contact is much simpler and faster to calculate for the solver. It is clear that such a simplification makes sense when in the MultiBody system one is not specifically interested in the interaction of these two cylinders and can therefore approximate their contact to the 2D case.

The first stage of the method implemented by the MultiBody simulation computer of a mechanized process of flexible document transport in at least one flexible document transport machine according to the invention is the contact detection, which can be performed alternatively according to:
an analytical technique, in which geometries are represented exactly by mathematical functions; or
based technique, in which the geometries are discretized more or less finely with a mesh of first-order triangular elements; in this case, it is possible to choose whether to evaluate the displacements, velocities and contact forces at the nodes or at the centres of the elements.
   Although the analytical technique is better, since the penetration is detected precisely and does not depend on the mesh quality, and is also much faster, it is still applicable only for simple geometries, e.g. for a cylinder-cylinder contact.

In general, to model the contact between the banknote decomposed into a plurality of rigid bodies and the elements of the transport machine, having any geometries, the technique used in the invention is mesh-based. However, this does not preclude the possibility of applying the analytical method for contacts between rigid bodies and cylinders, which can represent rollers. The invention also allows to simplify the geometries of a CAD, admitting that the complex shape of the bodies does not significantly impact the results of the analysis and can therefore be simplified. As mentioned, using the analytical approach in the detection of contacts the calculation times are reduced.

In the case where it is not possible to avoid using complex geometries and, consequently, the mesh-based technique, the simulation method according to the invention creates a mesh fine enough to be able to accurately model the contact. In fact, only the portion of the mesh in contact affects the calculation times, while the fact that there are numerous other triangular elements on the entire machine element does not have an impact. Furthermore, it is possible to specify to the solver to take into account the centers or the edges of the elements. In the latter case, more contact points are available and therefore the results are more accurate.

MultiBody simulation computer of a mechanized process of flexible document transport in at least one flexible document transport machine according to the invention is the calculation of contact forces F_{contac}, which always occurs when the penetration depth z between the elements is less than zero, where the penetration z is defined as the distance between two geometries, which is always positive and non-zero when the bodies are not in contact:

$${F}_{contact} = \{ \begin{matrix}0 & z \geq 0 \\ f ( z , \dot{z} ) & z < 0\end{matrix}$$

In the preferred embodiment of the invention, where MotionSolve® is used, the Poisson model is chosen among the three models Impact, Poisson, Volume to calculate the normal force, because it has parameters that are easier to interpret. The normal force F_{N} is composed of an elastic component F_{spring}, responsible for repelling the bodies, and a damping component F_{damping}, responsible for dissipating energy:

$${F}_{N} = {F}_{spring} + {F}_{damping}$$

The elastic component F_{spring} is equal to:

$${F}_{spring} = k \cdot \sqrt{{z}^{3}}$$

where k represents the contact stiffness and depends on the materials of the two elements. Generally, k is chosen based on the z permissible penetration value: the lower the z permissible penetration value, the greater the k contact stiffness. The damping component F_{damping} is equal to:

$${F}_{damping} = - {F}_{spring} [ ( \frac{1 - {C}_{R}^{2}}{1 + {C}_{R}^{2}} ) \cdot s ]$$

where the function s is the penetration velocity, C_{R} is the coefficient of restitution, defined as the ratio of the relative velocity v_{r,a} between the elements after contact and the relative velocity v_{r,b} among the elements before contact:

$${C}_{R} = {v}_{r , a} / {v}_{r , b}$$

The coefficient C_{R} of restitution varies from 0 to 1: a value of 0 (zero) implies a perfectly plastic contact, that is, the two bodies remain ‘attached’ after contact and all the energy is dissipated, while a value of 1 implies a perfectly elastic contact, that is, the two bodies bounce after contact and all the energy is conserved.
Finally, the formula for strength Fₐₜₜ of tangential friction is Coulomb's law:

$${F}_{att} = μ \cdot {F}_{N}$$

where μ is the coefficient of friction and F_{N} is again the normal force.

The MDL and Python® languages, in the implementation of the preferred embodiments of the invention, have made it possible to define thousands of contact entities between the rigid bodies 110 that make up the banknote 100 and all the other elements of the transport machine. In fact, a banknote discretized with 200 rigid bodies 110 and in contact with four cylinders, for example, requires the definition of 800 contacts in total, because it is necessary to represent the contact between each rigid body 110 and all the other elements of the transport machine. Advantageously, the parameters of the contact forces such as the stiffness, the coefficient of restitution, and the coefficient of friction, have been inserted into the MultiBody model as variables, so that it is possible to easily change their value from the graphical interface of the software without modifying the Python® code.

By decomposing the banknote 100, or other flexible document, into a plurality of rigid bodies 110, the invention allows for complete control over the ‘Banknote’ system because it is built from scratch with several elementary entities. Furthermore, the invention allows for changing the properties of the banknote to the millimeter in any area of its surface. Non-linearity can be assigned through non-linear curves to the rigidities. Although deformations are only considered in the connections, while the banknote 100 is composed of a plurality of rigid bodies 110, and it is also necessary to develop codes to create the thousands of entities that make up the banknote 100, the decomposition of the banknote 100 into a plurality of rigid bodies 110 is extremely effective, reliable and trustworthy.

For the MultiBody simulation of banknote transport, once the codes have been developed, a tool is available that automatically generates the MDL files that make up the ‘Banknote’ system, customizable with input data such as its size, the number of bodies to discretize it, and the rigidity of the connections. Furthermore, the contact between rigid bodies is easy to calculate and manage by the solver, for example the MotionSolve® solver by Altair®.

The inventors have performed a series of simulations on simplified MultiBody elements of a transport machine, consisting of a support plane, i.e. a parallelepiped-shaped element, and rollers, i.e. cylindrical-shaped elements. These simulations have demonstrated how the banknote 100, which in the model is decomposed into a plurality of rigid bodies 110, actually functions in the mechanized transport process and behaves as a globally flexible body. Furthermore, since the models are made up of few elements, the simulation times are very short, specifically in the order of ten minutes, and it is possible to quickly change the model parameters and analyze the results. The simulations were conducted with:
a first MultiBody model comprising four pairs of drive rollers and counter-rollers, in which the counter-rollers press on the rollers and contribute to generating the necessary drag force to make the banknote travel, with the aim of verifying that the banknote 100 is transported at the desired speed; in the machine the springs act on a shaft on which the counter-rollers are keyed, while in the model the application point was chosen, for simplicity, at the centre of mass of each counter-roller; the support surface is fixed to the Ground with a fixed joint, the drive rollers can rotate around their own longitudinal axis and a speed law is applied which interpolates from 0 up to 186.7 rad/s, while the counter-rollers do not have an applied motion, but can rotate around their own longitudinal axis and translate vertically with respect to the Ground; all contacts are modeled with mesh-based technique, so all elements have a mesh that influences the results, since the solver detects the interpenetration between the nodes of the triangular elements and consequently calculates the contact forces; FIGS. 11 and 12 show four frames resulting from the simulation with the first MultiBody model at the instants 0 milliseconds, 18 milliseconds, 30 milliseconds and 50 milliseconds, respectively;

MultiBody model comprising 4 drive rollers and 2 counter-rollers, similar to the first model from which it differs for the lack of counter-rollers on the first row, with the aim of verifying that the banknote is gripped on the second row of two rollers and one counter-roller since the drag force is much lower; FIGS. 13 and 14 show four frames resulting from the simulation with the second MultiBody model at the instants 0 milliseconds, 66 milliseconds, 75 milliseconds and 100 milliseconds, respectively; and
MultiBody model with a tilted banknote and with the aim of verifying the correction of the banknote tilt by changing the speeds of the rollers on the second row, where, given the angular velocity of the rollers in normal conditions, ω₀ the speed of the first roller on the second row is decreased by a certain amount ω₁, and the speed of the other drive roller is increased by the same amount; the code developed to generate the points that make up the banknote with parameterized coordinates allows the application of a rigid rotation in a very fast and simple way; FIGS. 15 and 16 show four frames resulting from the simulation with the third MultiBody model at the instants 0 milliseconds, 24 milliseconds, 64 milliseconds and 80 milliseconds, respectively.
   In the simulations, the dimensions of the rollers and the characteristics of the compression springs are referred to real components.

The results of the three simulations on simplified models have demonstrated that the model of the banknote 100 decomposed into a plurality of rigid bodies 110 is effective, reliable and trustworthy in modeling paper transport. In particular, with the MotionSolve® solver, to simulate 50 milliseconds, approximately 4 minutes of processing are required with a time step of one hundredth of a millisecond, i.e. equal to 0.01 milliseconds, which increases to approximately 25 minutes with a time step of one microsecond, i.e. equal to 0.001 milliseconds. This means that the simulation times are rather limited.

These results were also confirmed by a simulation of the transport of the banknote in a real application, using as a MultiBody system the model of a peeler of an automatic machine, which allowed to verify that only one banknote was peeled at a time, ensuring the correct functioning of the machine. In this simulation, the MultiBody model of the peeler was built on MotionView® by importing the CAD file of the peeler. All the elements are treated as rigid, so the information on the material they are made of was not relevant for the deformations but rather for the contact parameters, i.e. contact stiffness and friction coefficient. The motion transmitted by a motor to the pre-peeling and peeling rollers via a belt mechanism was simulated, in which the pre-peeling rollers drag the banknote into contact with the peeling rollers and the skimming rollers: when the rubber of the peeling rollers comes into contact with the banknote, it manages to pass through the rejection rollers, and the fast dragging of the banknote occurs thanks to the towing rollers which press forcefully on it.

Therefore, the model of banknote and contacts according to the invention is effective, reliable and trustworthy in simulating paper transport in a MultiBody system, and constitutes a tool for testing different construction solutions for the paper transport mechanism. It is possible to change both the characteristics of the banknote, or other flexible document, and those of the other elements of the transport machine, such as adding rollers of different shapes and materials, and verify how the banknote behaves overall. In this way, it is possible to discard a priori unsuccessful solutions without having to build any physical prototype.

In the foregoing, preferred embodiments have been described and variations of the present invention have been suggested, but it is to be understood that those skilled in the art may make modifications and changes without thereby departing from the scope of protection as defined by the appended claims.

1. A computer-implemented model of a flexible document configured to be used in a computer-implemented method of MultiBody simulation of a mechanised flexible document transport process, wherein the flexible document is in the shape of a parallelepiped, wherein the flexible document is decomposed into one or more layers, wherein each layer of said one or more layers comprises a plurality of rigid bodies shaped as a parallelepiped, wherein each rigid body has a longitudinal axis, a transverse axis orthogonal to the longitudinal axis, and a thickness axis orthogonal to both the longitudinal axis and the transverse axis, wherein each rigid body is connected to all rigid bodies that are adjacent to it along both its longitudinal axis and its transverse axis by means of a plurality of connecting elements connected to connection edges of adjacent rigid bodies, wherein the connecting edges of each rigid body are parallel to the thickness axis, wherein each connecting edge of each connected rigid body is connected to a connecting edge of a rigid body adjacent to it by means of
a first connection spring having a rotational stiffness about a rotation axis that is orthogonal to the thickness axis of said connected rigid body and to the axis along which the connected rigid body is connected to the adjacent rigid body,
and wherein each connecting edge of each connected rigid body is also connected to a connecting edge of a rigid body adjacent to it by a connecting structure selected from the group comprising or consisting of
a set of further three connection springs consisting of a second connection spring having a translational stiffness along the longitudinal axis of said connected rigid body, a third connection spring having a translational stiffness along the transverse axis of said connected rigid body, and a fourth connection spring having a translational stiffness along the thickness axis of said connected rigid body, and
a connecting ball joint.

2. Computer-implemented model of a flexible document according to claim 1, wherein each connecting edge of each connected rigid body is connected to a connecting edge of a rigid body adjacent thereto by means of:
a first connection damper having a rotational damping factor about a rotational axis that is orthogonal to the thickness axis of said connected rigid body and to the axis along which the connected rigid body is connected to the adjacent rigid body,
and, when said connecting structure consists of said set of further three connection springs, each connection edge of each connected rigid body is also connected to a connection edge of a rigid body adjacent thereto by a set of further three connection dampers consisting of a second connection damper having a translational damping factor along the longitudinal axis of said connected rigid body, a third connection damper having a translational damping factor along the transverse axis of said connected rigid body, and a fourth connection damper having a translational damping factor along the thickness axis of said connected rigid body.

3. Computer-implemented model of a flexible document according to claim 2, wherein each connection element of said plurality of connecting elements is connected to a corresponding connection edge of a respective rigid body of said plurality of rigid bodies at a mean plane which is parallel to both the longitudinal axis and the transverse axis of the respective rigid body and on which a center of mass of the respective rigid body lies.

4. Computer-implemented model of a flexible document according to claim 3 wherein each end of the first connection damper is connected to a corresponding connection edge of a respective rigid body of said plurality of rigid bodies at the mean plane of the respective rigid body, and, when said connection structure consists of said set of further three connection springs, each end of said further three connection dampers is connected to a corresponding connection edge of a respective rigid body of said plurality of rigid bodies on the mean plane of the respective rigid body.

5. Computer-implemented model of a flexible document according to claim 1, wherein said rotational stiffness of said first connection spring is non-linear and, when said connection structure consists of said set of further three connection springs, the translational stiffness of each of said further three connection springs is non-linear.

6. Computer-implemented model of a flexible document according to claim 1, wherein said one or more layers are two or more layers and wherein each connecting edge of each rigid body of a layer of said two or more layers is connected to a connecting edge of a rigid body adjacent thereto along the thickness axis by a thickness connection spring having a translational stiffness along the thickness axis.

7. Computer-implemented model of a flexible document according to claim 1, obtained by automation using the Python language.

8. Computer-implemented model of a flexible document according to claim 1, wherein said flexible document is a banknote.

9. Computer-implemented model of a flexible document according to claim 2, wherein each connection element of said plurality of connecting elements is connected to a corresponding connection edge of a respective rigid body of said plurality of rigid bodies at a mean plane which is parallel to both the longitudinal axis and the transverse axis of the respective rigid body and on which a center of mass of the respective rigid body lies.

10. A computer-implemented method of simulating a mechanized flexible document transport process in at least one flexible document transport machine, wherein the computer-implemented method is based on a computer-implemented model of a flexible document, wherein the flexible document is in the shape of a parallelepiped, wherein the flexible document is decomposed into one or more layers, wherein each layer of said one or more layers comprises a plurality of rigid bodies shaped as a parallelepiped, wherein each rigid body has a longitudinal axis, a transverse axis orthogonal to the longitudinal axis, and a thickness axis orthogonal to both the longitudinal axis and the transverse axis, wherein each rigid body is connected to all rigid bodies that are adjacent to it along both its longitudinal axis and its transverse axis by means of a plurality of connecting elements connected to connection edges of adjacent rigid bodies, wherein the connecting edges of each rigid body are parallel to the thickness axis, wherein each connecting edge of each connected rigid body is connected to a connecting edge of a rigid body adjacent to it by means of
a first connection spring having a rotational stiffness about a rotation axis that is orthogonal to the thickness axis of said connected rigid body and to the axis along which the connected rigid body is connected to the adjacent rigid body,
and wherein each connecting edge of each connected rigid body is also connected to a connecting edge of a rigid body adjacent to it by a connecting structure selected from the group comprising or consisting of
a set of further three connection springs consisting of a second connection spring having a translational stiffness along the longitudinal axis of said connected rigid body, a third connection spring having a translational stiffness along the transverse axis of said connected rigid body, and a fourth connection spring having a translational stiffness along the thickness axis of said connected rigid body, and
a connecting ball joint,
wherein at least one element of said at least one flexible document transport machine is modeled as a rigid body, the computer-implemented method comprising:
a first phase of detecting a contact between the flexible document and said at least one element of the flexible document transport machine, and
a second phase of calculation of contact forces,
wherein contact between the flexible document and said at least one element of the flexible document transport machine is recognized when a distance between the flexible document and said at least one element of the flexible document transport machine is less than zero, wherein said distance is defined as the penetration depth.

11. Computer-implemented method according to claim 10, wherein the first detection step is performed by representing the flexible document and/or said at least one element of the flexible document transport machine by one or more respective mathematical functions, wherein at least one of said one or more respective mathematical functions is optionally obtained from a CAD geometry.

12. Computer-implemented method according to claim 11, wherein at least one of said one or more respective mathematical functions is obtained from a CAD geometry.

13. Computer-implemented method according to claim 10, wherein the first detection step is performed by representing the flexible document and/or said at least one element of the flexible document transport machine by a discretization with a mesh of first-order triangular elements.

14. A system of MultiBody simulation of a mechanised process of transport of flexible documents in at least one flexible document transport machine comprising one or more processing units configured to execute the computer-implemented method of MultiBody simulation of a mechanised process of transport of flexible documents in at least one flexible document transport machine according to claim 10.

15. A set of one or more computer programs comprising instructions which, when executed by one or more processing units of a system of MultiBody simulation of a mechanised process of transport of flexible documents in at least one flexible document transport machine, cause said one or more processing units to execute the computer-implemented method of MultiBody simulation of a mechanised process of transport of flexible documents in at least one flexible document transport machine according to claim 10.

16. A set of one or more computer-readable storage media having stored thereon the set of one or more computer programs according to claim 15.
